(19) United States
(12) Patent Application Publication
(10) Pub. No.: US 2025/0255702 A1
(43) Pub. Date: Aug. 14, 2025

(54) SYSTEM AND METHOD FOR CLEANING SPACE BETWEEN FIXED DENTURES AND GUM LINES

(71) Applicants: ROBERT CHOE, BALTIMORE, MD (US); BLAKE KUZEMCHAK, FOREST HILL, MD (US); ALEJANDRO VENABLE-CROFT, EDGEWATER, MD (US)

(72) Inventors: ROBERT CHOE, BALTIMORE, MD (US); BLAKE KUZEMCHAK, FOREST HILL, MD (US); ALEJANDRO VENABLE-CROFT, EDGEWATER, MD (US)

(21) Appl. No.: 19/046,658

(22) Filed: Feb. 6, 2025

Related U.S. Application Data
(60) Provisional application No. 63/551,484, filed on Feb. 8, 2024.

(51) Int. Cl. A61C 17/02; A61C 17/08; A61C 17/12

(52) U.S. Cl. CPC A61C 17/0211; A61C 17/08; A61C 17/12

(57) ABSTRACT

A system for cleaning space between dentures and gum lines that has a substantially planar, flexible mouthpiece with a longitudinal axis. A proximal end of the mouthpiece substantially forms a crescent. A distal end of the mouthpiece stems perpendicularly from the proximal end of the mouthpiece. The mouthpiece has coplanar ingress half and egress half separable by a central planar axis. The ingress half has a plurality of ingress proximal ports fluidly connected to at least one ingress distal port. The egress half has a plurality of egress proximal ports fluidly connected to at least one egress distal port. Pressure differentials in the ingress fluid channel propel fluid out of the ingress proximal ports. Pressure differentials in the egress fluid channel draw at least fluid into the egress proximal ports. Pressure differentials in the ingress and egress fluid channels are designed to be generated simultaneously by a pump and vacuum.

### FIELD OF THE INVENTION

The inventive concept relates to a system for cleaning implants abutments associated with fixed dentures after retaining them on dental implants.

### BACKGROUND

Dental implants are robust titanium screw-like posts that dentists commonly use to replace lost teeth. A fixed denture (also referred to as hybrid denture, implant complete denture, implant-supported denture, or implant-retained denture, though not exclusively) is a type of dental implant prosthesis that is connected to screw-like rods that are implanted into the jaw. The denture prosthesis is fixed to dental implants at specific connection points called abutments—synonymous with the term studs. These abutments are embedded underneath the prosthesis, so they are out of reach during most forms of oral debridement (i.e., flossing, water picks, and brushing). As such, the gingival portion of the dental implant, abutment, and intaglio surface of the fixed dentures often becomes a sanctuary for bacterial biofilm and promotes increased bacterial proliferation.

Initial ventures into the fluid jet debridement space were dominated by the WaterPik® and other similar devices. These devices use singular water jet streams directed into a centralized area to remove debris from the inter-dental space. These water jet designs, while effective, have a major caveat in that they can only focus on one localized area at a time and can be messy. Water used in a standard waterflosser allows water droplets to bounce off teeth and flow freely out of the mouth and into the surrounding space.

To improve upon the original design of WaterPik®, a new generation would address these problems by becoming multitargeted as well as self-cleaning. There have been previous endeavors into the multi-jet fluid debridement space, namely a device called Proclaim™ from Fresh Health Inc. The Proclaim device uses several targeted water jets aimed at the interdental space (between teeth) and is customized to each patient with a formed mouthpiece.

The Proclaim™ device, however, is designed for patients with organic teeth and neglects those who have dentures and implant-supported prostheses. Patients with these types of oral prosthesis cannot benefit from the Proclaim device due to lacking interdental space. The Proclaim device also alienates patients with fixed denture prostheses. The Proclaim device is bulky and fits over natural teeth, and in the case of hybrid dentures, not only is there no interdental space the location of interest, but also the seam between the prosthesis and gingiva is ignored. Therefore, there is a need in the market for a new device that can clean the area between dentures and gum lines to provide simplified debridement of the area without a major procedure.

### SUMMARY OF THE INVENTION

Disclosed is a system for cleaning space between dentures—especially between the intaglio surface of the denture prosthesis, though not exclusively—and gum lines, particularly one or more of a gingiva or alveolar ridge, comprising a flexible mouthpiece. The mouthpiece is typically planar, and can be bilaterally divided along a longitudinal axis so as to have a first side and a second side. A proximal end of the mouthpiece substantially forms a crescent wherein the mouthpiece resembles a Y with the crescent overlaying the diagonal strokes of the Y. A distal end of the mouthpiece extends perpendicularly from the proximal end of the mouthpiece on the longitudinal axis and would overlay the vertical stem of the Y, though the effect has a crescent curvature at the edges designed to approximate the curvature of typical human teeth and gums. The mouthpiece has an ingress half and an egress half, the ingress half having a plurality of ingress proximal ports fluidly connected to at least one ingress distal port by a branched ingress fluid channel. and the egress half having a plurality of egress proximal ports fluidly connected to at least one egress distal port by a branched egress fluid channel.

The mouthpiece typically has a coplanar configuration with said ingress half and said egress half separable by a central planar axis parallel to the longitudinal axis and though which the longitudinal axis travels, giving the mouthpiece a top half and a bottom half. These halves, when coupled, form the main body of the complete mouthpiece. Pressure differentials in the ingress fluid channel propel fluid out the ingress proximal ports generally into a user's mouth. Pressure differentials in the egress fluid channel draw at least fluid generally within the user's mouth into the egress proximal ports, with the fluid also intended to carry small particulates from user mouths. The pressure differentials may further be described as a pump and a vacuum respectively, and both are generated by a respective fluid pump and vacuum. The pressure differentials in the ingress fluid channel and the egress fluid channel are designed to be generated simultaneously so that as fluid, usually water, is jetted into a user's mouth, fluid often with debris will be vacuumed from that user's mouth.

In the preferred embodiment of the system for cleaning space between dentures and gum lines, the mouthpiece is composed of a silicon-based compound. Polymers may also be used.

In one embodiment of the system for cleaning space between dentures and gum lines, there are four ingress proximal ports. These four to six ingress proximal ports may be designed to substantially align with denture mounting abutments. In some embodiments at least the ingress proximal ports are designed to clip onto the denture mounting abutments. In other embodiments, the ingress and egress ports lie solely on the lingual and/or buccal side of the denture.

The structure of the system may vary from a full arch design to a partial arch design. In one embodiment, the full arch system spans from the molar region of one quadrant to the opposite molar region. In a separate embodiment in a partial arch structure, the system originates at the midline of the oral cavity and continues down a singular quadrant, either partially down the quadrant or fully to the molar region.

Disclosed also is a method for cleaning space between dentures and denture user gum lines, particularly the intaglio surface of the denture and the patient's gingival tissue, though not exclusively. The method uses 3 major components: 1) the mouthpiece, which is designed to have a low-profile such that the mouthpiece can be slipped into the gap between denture and denture user gum lines, 2) directed-stud fluid-jets which are the ingress proximal ports which are directed toward the abutments to the extent, in some embodiments, that the ports may clip right onto the abutments, and 3) operating a high-power fluid delivery system powerful enough to remove debris without harming the user or causing pain to healthy gums. Users may clip fluid-jet outlets, which are the ingress proximal ports, onto the denture mounting abutments to maintain the position of the device for the duration of treatment. Operating in unison with the fluid jets is a separate vacuum line that removes fluid and debris from the user's mouth by way of the egress proximal ports. Fluid would, therefore, first enter the mouthpiece through a fluid attachment such as a silicon or polymer tube at the ingress distal port and would ultimately exit—after jetting out of the ingress proximal ports and being sucked into an egress proximal port of the mouthpiece—out the egress distal port.

The disclosed system and method uses a combination of hydraulic pressure via multiple targeted water jets and a substantially planar form designed to fit into a cavity between the gum line and the denture. The system and method are designed to promote a rigorous cleaning between denture and denture user gum lines for patients at home (personal settings) and at dental offices (professional settings).

The inventive concept now will be described more fully hereinafter with reference to the accompanying drawings, which are intended to be read in conjunction with both this summary, the detailed description, and any preferred and/or particular embodiments specifically discussed or otherwise disclosed. Inventive concepts may, however, be embodied in many different forms and should not be construed as limited to the embodiments set forth herein; rather, these embodiments are provided by way of illustration only and so that this disclosure will be thorough, complete, and will fully convey the full scope of the inventive concepts to those skilled in the art.

### BRIEF DESCRIPTION OF THE DRAWINGS

FIG. 1 is a perspective view of the system for cleaning space between dentures and gum lines with an exploded view separating fluid ingress and egress systems.

FIG. 2A is a view of a fluid channel system with ingress points labeled.

FIG. 2B is a view of a fluid channel system with egress points labeled.

FIG. 3A is a second perspective view, a surface top or bottom view, an interior view, and a proximal front view of the system for cleaning space between dentures and gum lines with a back view position of a distal port circled.

FIG. 3B illustrates fluid channels.

FIG. 3C illustrates a proximal port.

FIG. 4 illustrates a representative method for using the system for cleaning space between dentures and gum lines.

FIG. 5 illustrates the greater system overall for moving fluids through the system for cleaning space between dentures and gum lines, particularly into and out from the mouthpiece.

FIG. 6 illustrates the alignment of a representative mouthpiece with one or more abutments implanted in a user or patient of representative dentures.

FIG. 7 illustrates a second representative method for using the system for cleaning space between dentures and gum lines.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

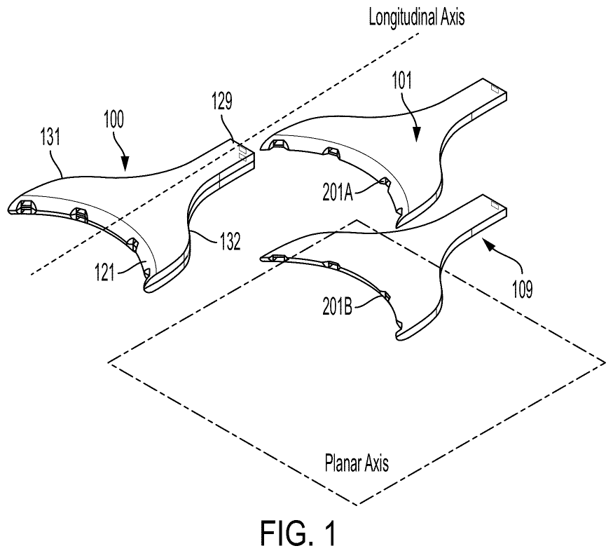

The disclosed system and method will now be discussed in detail in reference to drawings presented in the previous section. As represented in FIG. 1, a representative embodiment of mouthpiece 100 is illustrated that has a height up to about 4 millimeters. Mouthpiece 100 could be taller, but such might alter its efficiency at reaching targeted gum line abutments. Mouthpiece 100 could be shorter, but such might alter the efficiency of fluid flow. Mouthpiece 100 would preferably fit within an inter-denture space between a gumline and a denture. Mouthpiece 100 is designed to be slim enough to fit within a gap presented by dentures and gum lines with minimal impact on the surrounding bodies i.e., tissue and the denture body yet wide enough to provide fluid channels suitable for required fluid flow. In the example embodiment, mouthpiece 100 has a crescent shaped proximal end 121 and a distal end 129 stemming from proximal end 121.

In reference to FIG. 1, two separate system parts of mouthpiece 100 are present and are combined as a singular body. The representation presents an exploded view to illustrate dual systems. A planar axis is described in this disclosure that would be between the two separate system parts between top ingress half 101 and bottom egress half 109 where positioning egress 109 at said bottom improves the natural flow of fluids due to gravity. In some embodiments, ingress half 101 and egress half 109 are structurally identical to each other, and which half operates is ingress half 101 or egress half 109 may depend on to which fluid tube the given half is connected, that pumping fluid to mouthpiece 100 or that vacuuming fluid from mouthpiece 100. Mouthpiece 100 further has a longitudinal axis bilaterally dividing right side 131 and left side 132. In preferred embodiments, during operation, egress half 109 is below ingress half 101, given that gravity will draw fluid downward in a user's mouth, and in some embodiments the respective halves may be further labeled in a lettering format that may be read or felt.

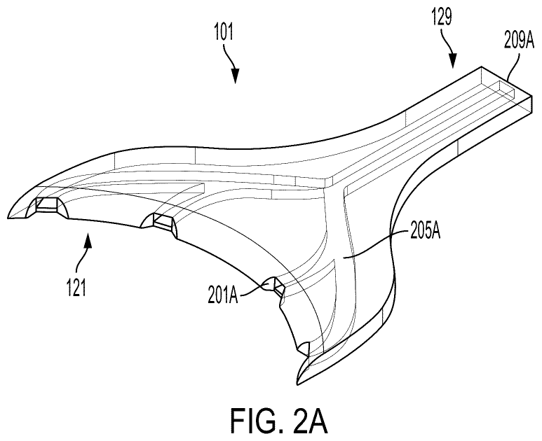

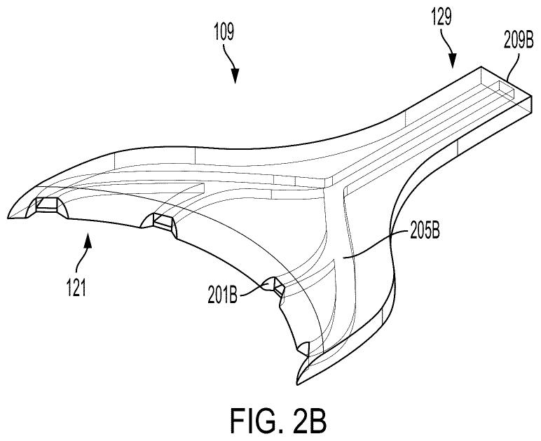

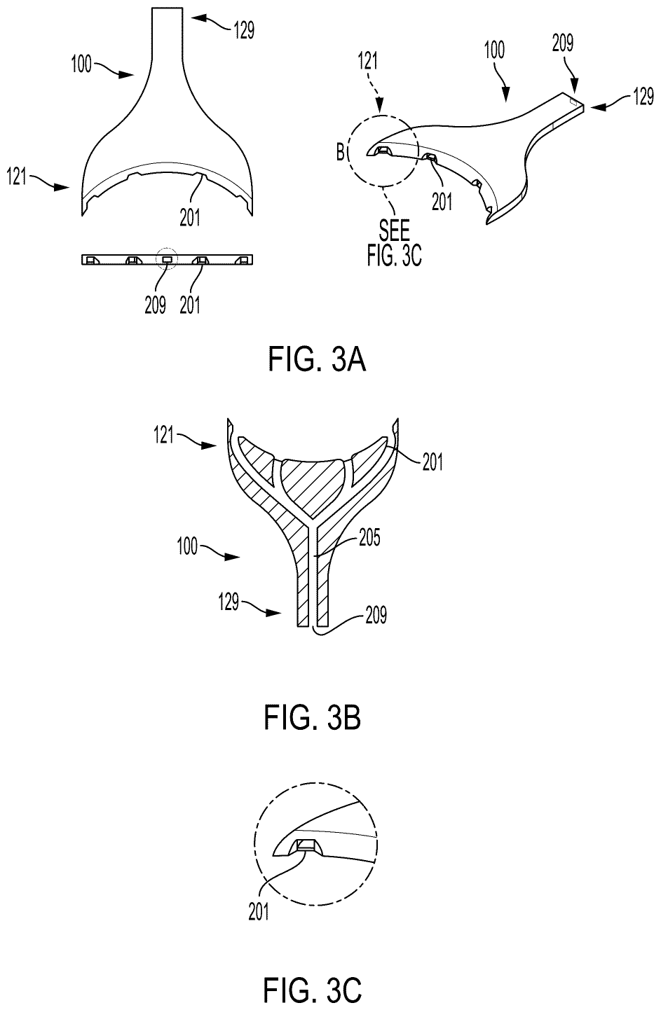

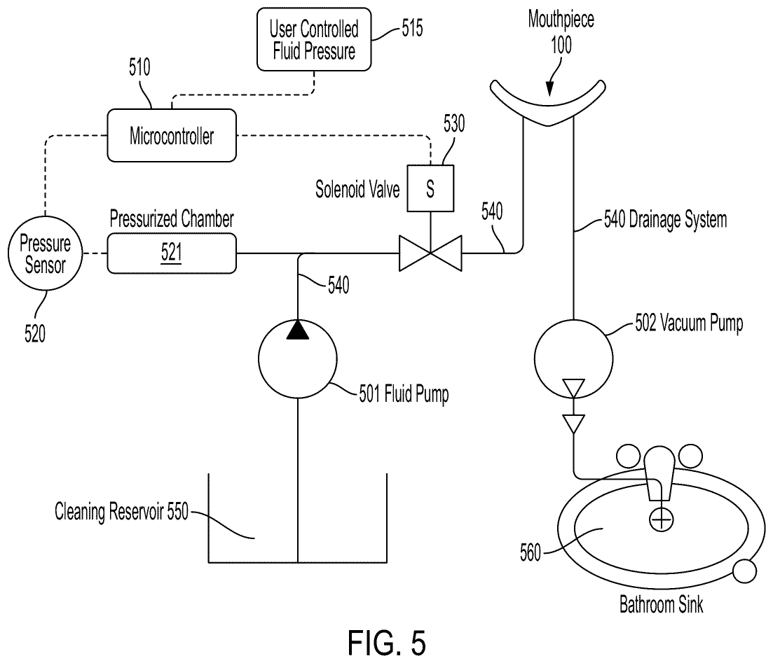

FIGS. 2A and 2B illustrate a set or a plurality of proximal ports 201A and 201B, which are common to both ingress half 101 and egress half 109 and may, as will be illustrated in FIG. 3A, generically be labeled 201. Distal ports 209A and 209B, likewise, are common to both ingress half 101 and egress half 109, may, as will be illustrated in FIG. 3A, generically be labeled 209. Fluid channels 205 generically include ingress fluid channels 205A and egress fluid channels 205B as they would appear in representative embodiments of both ingress half 101 and egress half 109 of mouthpiece 100. Fluid used for debris removal in this system enters through inlet port (ingress distal port 209A) at head (distal end 129) of mouthpiece 100. Fluid exits these ingress channels 205A via four outlet ports (ingress proximal ports 201A). Fluid used for debris removal in this system exits through egress proximal port 201B at proximal end 121 of mouthpiece 100. Fluid exits these egress channels 205B via outlet port (egress distal port 209B). Components of egress fluid channels 205B are mirror images to that of ingress fluid channels 205A and are designed to run in parallel and simultaneously. Fluid re-enters the system from a user's mouth in egress half 109. Egress half 109 is operatively connected to, as illustrated in FIG. 5, drainage system 540, and vacuum pump 502, which provides mouthpiece 100 with suction to remove debris and fluid from around denture mounting abutments, into at least one egress proximal port 201B and out egress distal port 209B. In some embodiments, fluid channels 205A and 205B may be formed of different patterns that are not mirror images.

FIGS. 3A-3C illustrate further views of mouthpiece 100 as previously discussed, including top, front, and interior views plus a closer illustration of a representative proximal port 201 which generically represents either 201A or 201B. Front view of mouthpiece 100 further illustrates proximal ports 201 and central positioning of distal port 209 on back side of mouthpiece 100.

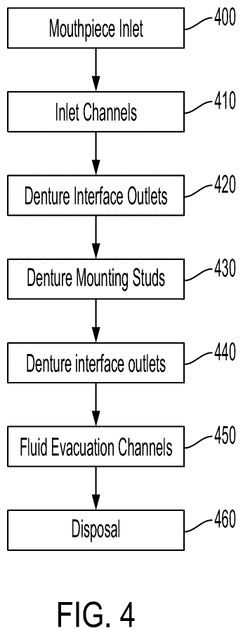

FIG. 4 illustrates a representative method for using the system for cleaning space between dentures and gum lines as described. These steps include the step of 400, fluid entering mouthpiece 100, the step of 410, fluid traveling through ingress fluid channel 205A, the step of 420 the fluid propelled from mouthpiece 100, the step of 430 having mouthpiece 100 align with denture abutments/studs, the step of 440, at least expended fluid drawn back into mouthpiece 100, the step of 450 fluid traveling through egress fluid channel 205B, and the step of 460, disposing the fluid.

The system for cleaning space between dentures and gum lines requires pumps to propel fluid, and as such, FIG. 5 presents a representative embodiment of components designed to propel fluid through mouthpiece 100. Importantly, the greater system for which disclosed mouthpiece 100 is a part includes at least one fluid pump assembly 501 designed to propel fluid into mouthpiece 100 and at least one vacuum pump assembly 502 designed to vacuum at least fluid from mouthpiece 100 wherein fluid lines have further controls such as solenoid valves 530 that a skilled artisan would recognize, as illustrated, that various additional components may be employed such as pressure sensors 520 and associated pressure chambers 521 and that any or all electronic components may have computer-based controls inclusive of a microcontroller 510, and user controls 515 which may be manually operated, computer-assisted, or both. Also illustrated is a fluid reservoir 550 containing water, an aqueous solution, or another fluid, and preferably a fluid disposal system 560 such as a sink. Silicon or polymer tubes of drainage system 540 provide passageways to-and-from pumps 501, 502 and to-and-from disclosed mouthpiece 100. In some embodiments, users may self-generate force to expel fluid, but this is not the preferred embodiment and would likely require fluid pressure differentials to be created intermittently.

The method of manufacturing mouthpiece 100 and its associated evacuation system, will now be discussed in detail with reference to the drawings in the previous section. The primary unit of the device or system is mouthpiece 100 of a slim contour, such as the representative 4 mm width, made preferably, but not exclusively, with a flexible silicone-derived resin and may be molded or 3D printed. The utilization of flexible, low-modulus materials like silicone materials will provide mouthpiece 100 with the ability to mitigate hard-edge collisions along the gumline via easy body distortion. The low surface friction associated with silicone also will improve the devices' ability to maneuver into the tighter inter-denture space separating the gums from the many denture bodies. In some embodiments, mouthpiece 100 may include a more rigid body of silicon or polymer where mouthpiece 100 does not contact human tissue.

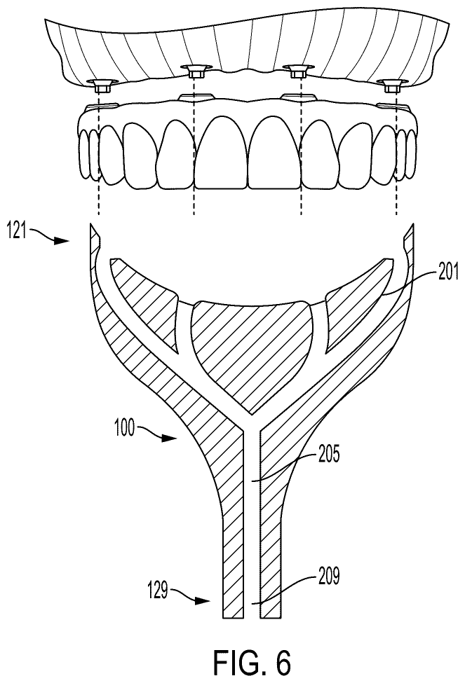

FIG. 6 illustrates alignment of a mouthpiece 100 with a user's abutments of representative dentures presented in the upper portion of the illustration. Here 201 is used generically to represent respective 201A or 201B of given ingress 101 and egress 109 halves. Here 209 is used generically to represent respective 209A or 209B of given ingress 101 and egress 109 halves.

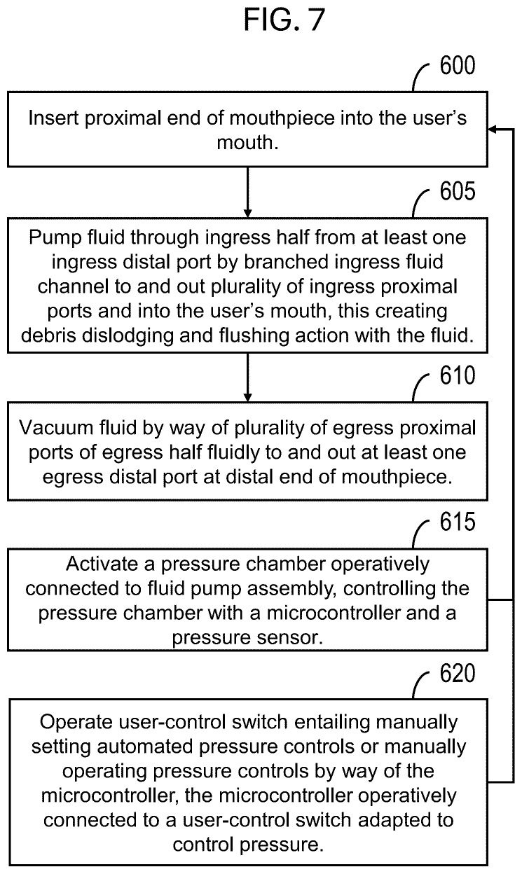

Included in FIG. 7 is a second representative method for cleaning space between dentures and gum lines and comprises the step of 600 inserting proximal end of mouthpiece 121 into the user's mouth. The method includes the step of 605 pumping fluid through ingress half 101 from at least one ingress distal port 209A by branched ingress fluid channel 205A to and out plurality of ingress proximal ports 201A and into the user's mouth, this creating debris dislodging and flushing action with the fluid. The method includes the step of 610 vacuuming fluid by way of plurality of egress proximal ports 201B of egress half 109 fluidly to and out at least one egress distal port 209B at distal end of mouthpiece 129. The method may include the step of 615 activating a pressure chamber 521 operatively connected to fluid pump assembly 501, controlling said pressure chamber 521 with a microcontroller 510 and a pressure sensor 520. The method may include the step of 620 operating user-control switch 515 entailing manually setting automated pressure controls or manually operating pressure controls by way of the microcontroller, the microcontroller operatively connected to a user-control switch adapted to control pressure.

The following patents are incorporated by reference in their entirety: Pat. Nos. U.S. Pat. Nos. 11,141,249B2, and 11,376,105B2.

While inventive concepts have been described above in terms of specific embodiments, it is to be understood that the inventive concepts are not limited to these disclosed embodiments. Upon reading the teachings of this disclosure, many modifications and other embodiments of the inventive concepts will come to mind of those skilled in the art to which these inventive concepts pertain, and which are intended to be and are covered by both this disclosure and the appended claims. It is indeed intended that the scope of the inventive concepts should be determined by proper interpretation and construction of the appended claims and their legal equivalents, as understood by those of skill in the art relying upon the disclosure in this specification and the attached drawings.

### REPRESENTATIVE ELEMENTS

100 Mouthpiece
101 Ingress half
109 Egress half
121 Proximal end of mouthpiece
129 Distal end of mouthpiece
131 Right side of mouthpiece
132 Left side of mouthpiece
201 Proximal ports
201A Ingress proximal ports
201B Egress proximal ports
205 Fluid channels
205A Ingress fluid channels
205B Egress fluid channels
209 Distal ports
209A Ingress distal port
209B Egress distal port
501 Fluid pump assembly
502 vacuum pump assembly
530 Solenoid valves
520 Pressure sensors
521 Pressure chambers
510 Microcontroller
515 User controls
550 Fluid reservoir
560 Fluid disposal system
540 Silicon or polymer tubes

1. A system for cleaning space between dentures and gum lines comprising:
a substantially planar, flexible mouthpiece having a longitudinal axis bilaterally dividing a right side and a left side;
a proximal end of the mouthpiece substantially forming a crescent, a distal end of the mouthpiece stemming perpendicularly from the proximal end of the mouthpiece on the longitudinal axis;
the mouthpiece having a coplanar top ingress half and bottom egress half separable by a central planar axis coplanar to the longitudinal axis;
the ingress half having a plurality of ingress proximal ports fluidly connected to at least one ingress distal port by a branched ingress fluid channel;
the egress half having a plurality of egress proximal ports fluidly connected to at least one egress distal port by a branched egress fluid channel;
wherein pressure differentials in the ingress fluid channel propel fluid out the ingress proximal ports;
wherein pressure differentials in the egress fluid channel draw at least fluid into the egress proximal ports; and
wherein pressure differentials in the ingress fluid channel and the egress fluid channel are adapted to be generated simultaneously.

2. The system for cleaning space between dentures and gum lines of claim 1 wherein the mouthpiece is composed of a silicon-based compound.

3. The system for cleaning space between dentures and gum lines of claim 1 wherein there are four to six proximal ports.

4. The system for cleaning space between dentures and gum lines of claim 1 wherein the ingress proximal ports are adapted to substantially align with implanted denture mounting abutments.

5. The system for cleaning space between dentures and gum lines of claim 4 wherein the ingress proximal ports are adapted to clip onto the denture mounting abutments.

6. A system for cleaning space between dentures and gum lines comprising:
a flexible mouthpiece;
a proximal end of the mouthpiece substantially forming a crescent,
a distal end of the mouthpiece extending perpendicularly from the proximal end of the mouthpiece;
the mouthpiece having an ingress half and an egress half;
the ingress half having a plurality of ingress proximal ports fluidly connected to at least one ingress distal port; and,
the bottom egress half having a plurality of egress proximal ports fluidly connected to at least one egress distal port.

7. The system for cleaning space between dentures and gum lines of claim 6 wherein the mouthpiece is composed of a silicon-based compound.

8. The system for cleaning space between dentures and gum lines of claim 6 wherein there are four proximal ports.

9. The system for cleaning space between dentures and gum lines of claim 6 wherein the ingress proximal ports are adapted to substantially align with implanted denture mounting abutments.

10. The system for cleaning space between dentures and gum lines of claim 9 wherein the ingress proximal ports are adapted to clip onto the denture mounting abutments.

11. The system for cleaning space between dentures and gum lines of claim 6 wherein there are six ingress proximal ports.

12. A system for cleaning space between dentures and gum lines comprising:
a flexible mouthpiece;
a proximal end of the mouthpiece substantially forming a crescent,
a distal end of the mouthpiece extending perpendicularly from the proximal end of the mouthpiece;
the mouthpiece having an ingress half and an egress half;
the ingress half having a plurality of ingress proximal ports fluidly connected to at least one ingress distal port;
a fluid pump assembly with at least one solenoid valve assembly operatively connected to said ingress distal port;
the bottom egress having a plurality of egress proximal ports fluidly connected to at least one egress distal port; and
a vacuum pump assembly operatively connected to said egress distal port.

13. The system for cleaning space between dentures and gum lines of claim 12 further including a pressure chamber operatively connected to the fluid pump assembly, further operatively connected to a microcontroller and a pressure sensor.

14. The system for cleaning space between dentures and gum lines of claim 13 further including said microcontroller operatively connected to a user-control switch adapted to manually control pressure.

15. The system for cleaning space between dentures and gum lines of claim 13 further including a user-controlled switch for setting automated pressure controls.

16. The system for cleaning space between dentures and gum lines of claim 12 wherein the mouthpiece is composed of a silicon-based compound.

17. The system for cleaning space between dentures and gum lines of claim 12 wherein there are four proximal ports.

18. The system for cleaning space between dentures and gum lines of claim 12 wherein the ingress proximal ports are adapted to substantially align with implanted denture mounting abutments.

19. The system for cleaning space between dentures and gum lines of claim 18 wherein the ingress proximal ports are adapted to clip onto the denture mounting abutments.

20. The system for cleaning space between dentures and gum lines of claim 12 wherein there are six ingress proximal ports.
